(19) United States
(12) Patent Application Publication
(10) Pub. No.: US 2014/0130824 A1
(43) Pub. Date: May 15, 2014

(54) MULTIPLE STRAND DENTAL FLOSSER

(71) Applicants: Jeffrey J. Fisher, Ada, MI (US); Scott P. Crossman, Rockford, MI (US); Kevin J. Kollar, Ada, MI (US); Chad E. Kleinheksel, Zeeland, MI (US); Ingram S. Chodorow, Rancho Santa Fe, CA (US)

(72) Inventors: Jeffrey J. Fisher, Ada, MI (US); Scott P. Crossman, Rockford, MI (US); Kevin J. Kollar, Ada, MI (US); Chad E. Kleinheksel, Zeeland, MI (US); Ingram S. Chodorow, Rancho Santa Fe, CA (US)

(73) Assignee: RANIR, LLC, Grand Rapids, MI (US)

(21) Appl. No.: 14/003,292

(22) PCT Filed: Mar. 8, 2011
(86) PCT No.: PCT/US11/27529

§ 371 Date: Jan. 17, 2014

(51) Int. Cl. A61C 15/04

(52) U.S. Cl. CPC A61C 15/046; A61C 15/041
USPC 132/323

(57) ABSTRACT

A dental flosser including a plastic handle having proximal and distal ends, a flosser head at the distal end of the handle, and two spaced apart arms extending from the flosser head. First and second strands of dental floss extend transversely between the spaced apart arms. The first and second strands may different material characteristics from each other, such as different coefficients of friction. The first and second strands may be arranged on the arms to provide enhanced cleaning. For instance, a portion of one of the strands may be offset from the other strand along the width of the flosser arms.

### BACKGROUND OF THE INVENTION

The present invention is in the field of disposable dental floss holders commonly called dental flossers, and more particularly to injection molded dental flossers which each include a handle and a head part with two spaced-apart arms supporting a strand of dental floss extended between and fixed to the distal ends of the arms.

In more recent years dental flossers have become widely used for removing plaque from tooth surfaces, particularly from the generally facing surfaces of adjacent teeth and for removing food particles from the interstices between adjacent teeth. Such interstices may be empty space or may be merely the interface areas of contact between the surfaces of adjacent teeth. For many persons a dental flosser is substantially easier to use than a conventional strand of dental floss wrapped about fingers of both hands and manipulated between teeth, by having fingers of one hand in the mouth and fingers of the other hand outside the mouth.

Typical prior art flossers are disclosed in U.S. Pat. Nos. 5,538,023 and 4,006,750 to Chodorow, U.S. Pat. No. 7,487,785 to Dougan et al., U.S. Pat. No. 6,756,158 to Gwen, U.S. Application No. 2008/0149134 to Crossman, and U.S. Pat. No. 7,204,257 to Crossman.

Initially, many dental flossers employed nylon floss because it was well known, readily available, relatively inexpensive and relatively easy to use in multi-cavity injection molding machines. Over time better dental flosses have been developed, particularly polytetrafluoraethylene (“PTFE”) commonly known as TEFLON®, and ultra high molecular weight polyethylene (“UHMWPE”), the latter dental floss disclosed in U.S. Pat. No. 5,113,880 to Honda. Teflon® floss has a significantly lower coefficient of friction than nylon and thus is far more slippery and easier to manipulate into the interstices between two adjacent teeth, but its disadvantages are stretching, shredding and breaking in vigorous use. Nevertheless, PTFE flossers were considered to be a substantial and popular improvement over nylon floss flossers.

As compared to nylon, UHMWPE dental floss has (a) significantly greater strength to resist stretching, shredding and breaking, and (b) significantly lower coefficient of friction than nylon, but not as low as that of PTFE floss. Thus, UHMWPE flossers generally require greater effort, finger dexterity and strength than PTFE flossers when penetrating tight spaces, but UHMWPE flossers have the advantage of little to no stretching or breakage in use. In summary, while nylon dental floss is employed in some flossers in multi-cavity injection molding, for many the preference is either PTFE floss as the most slippery or UHMWPE floss as the strongest and still quite slippery.

Also, in the prior art are dual strand dental flossers, each having a pair of closely adjacent strands of dental floss extending across the flosser head or bow portion, as disclosed in U.S. Pat. Nos. 5,692,531, 5,829,458 and D401,701. In such dual strand flossers there typically is a lead strand that is most remote from the base of the flosser head, and a follower strand that is parallel and closely adjacent to the lead strand and closer to the base of the flosser head. The two stands are intended to provide more plaque-scrubbing surface area of the floss material so that for each stroke of the flosser in either the axial or transverse direction of the floss, more tooth surface area is scrubbed by two strands instead of by one strand. The follower strand, often spaced about one to five millimeters behind the lead strand, scrubs or wipes immediately after the lead strand.

Prior art dual strand flossers have two strands of floss, both strands being of the same material, such as nylon, PTFE or UHMWPE, the choice of material being based upon: (1) the floss characteristics of interest, (2) the theory that two strands produce twice the scraping surface of one of whatever floss was selected, and (3) the logical conclusion that it is easier in conventional manufacturing processes (which require engagement and stretching the strands across the multi-cavities of a mold), to apply the same stretching force and floss engagement apparatus to both adjacent strands. Thus, the prior art dual strand flossers have either two strands of PTFE floss, or two strands of UHMWPE floss, or two stands of nylon floss.

### SUMMARY OF THE INVENTION

The present invention provides a multiple strand dental flosser wherein the features of each individual floss strand are selected to provide particular floss advantages.

In one embodiment, the present invention includes a dual strand flosser where the strands have different material characteristics. For instance, in one embodiment, the lead strand has a lower coefficient of friction than the follower strand. More particularly, the lead strand may comprise PTFE microfibers and the follower strand may comprise UHMWPE microfibers, the two strands being generally parallel and extending between and fixed to the end portions of the arms of a flosser head.

In another embodiment, the present invention provides a dual strand flosser where the follower strand is about 400 denier UHMWPE floss of about 120 microfilaments in a Z twist configuration. The UHMWPE strand may have about four twists per inch added to its natural condition, the additional twists maintained during injection molding and subsequent cooling and hardening of the plastic in the flosser head and handle.

The differences in material characteristics of the two strands, such as the lower coefficient of friction of the lead strand, may make it easier for a user to achieve insertion of the floss into a tight interspace between two adjacent teeth. The follower strand of UHMWPE provides higher strength and greater resistance to shredding or stretching during vigorous flossing. Also, the UHWMP follower strand being immediately behind and stronger than the PTFE strand, can support this lead strand from excessive stretching.

In another embodiment, the floss strands are arranged to provide an enhanced cleaning effect. For example, at least a portion of one of the floss strands may be positioned at a different location along the width of the arms than the other of the floss strands.

The floss strands may extend generally parallel to each other, with one floss strand being offset from the other floss strand along the width of the arms, such that the floss strands lie in a plane that extends at an angle to the longitudinal length of the flosser arms.

The floss strands may otherwise be arranged such that they are not parallel to each other. For example, the first end of one floss strand may be positioned closer to the front surface of the flosser arms than the first end of the other floss strand, with the second end of the one floss strand being farther from the front surface than the second end of the other floss strand. As a result, the floss strands may cross each other. In another arrangement, the floss strands may also be positioned such that the first end of one floss strand is positioned closer to the distal end of the arms than the first end of the other floss strand, and the second end of the one floss strand is farther from the distal end than the second end of the other floss strand, such that the floss strands cross each other in two directions. Optionally, the floss strands may contact each other at the location where the strands cross.

The arrangement of the floss strands, with at least a portion of one strand being offset from the other strand along the width of the flosser arms, enables increased engagement between the floss strands and the teeth as the floss strands are inserted between the teeth. In the embodiments wherein the strands cross each other, the strands may be moved back and forth to change the amount of engagement between the floss strands and the teeth.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a dental flosser according to one embodiment of the present invention;

FIG. 2 is a sectional bottom view taken along line 2-2 in FIG. 1 showing a lead strand of dental floss of a material different from that of a follower strand;

FIG. 3 is an enlarged fragmentary elevation view showing insertion of a lead strand of floss of the flosser of FIG. 1 into the inter-dental space between two adjacent teeth in a person's mouth;

FIG. 4 is a perspective view of a dental flosser according to a second embodiment of the present invention;

FIG. 5 is a front view thereof;

FIG. 6 is a side view thereof;

FIG. 7 is a top perspective view of a dental flosser according to a third embodiment of the present invention;

FIG. 8 is a front view thereof;

FIG. 9 is a bottom perspective view thereof;

FIG. 10 is a perspective view of a dental flosser according to a fourth embodiment of the present invention;

FIG. 11 is a top view thereof;

FIG. 12 is a side view thereof;

FIG. 13 is a front view thereof;

FIG. 14 is a top perspective view of a dental flosser according to a fifth embodiment of the present invention;

FIG. 15 is a bottom perspective view thereof;

FIG. 16 is a front view thereof;

FIG. 17 is a top view thereof;

FIG. 18 is a top perspective view of a dental flosser according to a sixth embodiment of the present invention;

FIG. 19 is a bottom perspective view thereof;

FIG. 20 is another bottom perspective view thereof;

FIG. 21 is a front view thereof;

FIG. 22 is a top view thereof.

FIG. 23 is a bottom perspective view of a dental flosser according to a seventh embodiment of the present invention;

FIG. 24 is a top perspective view thereof;

FIG. 25 is another bottom perspective view thereof;

FIG. 26 is a front view thereof;

FIG. 27 is a top view thereof.

FIG. 28 is a perspective view of a flosser according to an eighth embodiment of the present invention.

FIG. 29 is a front view thereof.

### DETAILED DESCRIPTION OF THE CURRENT EMBODIMENTS

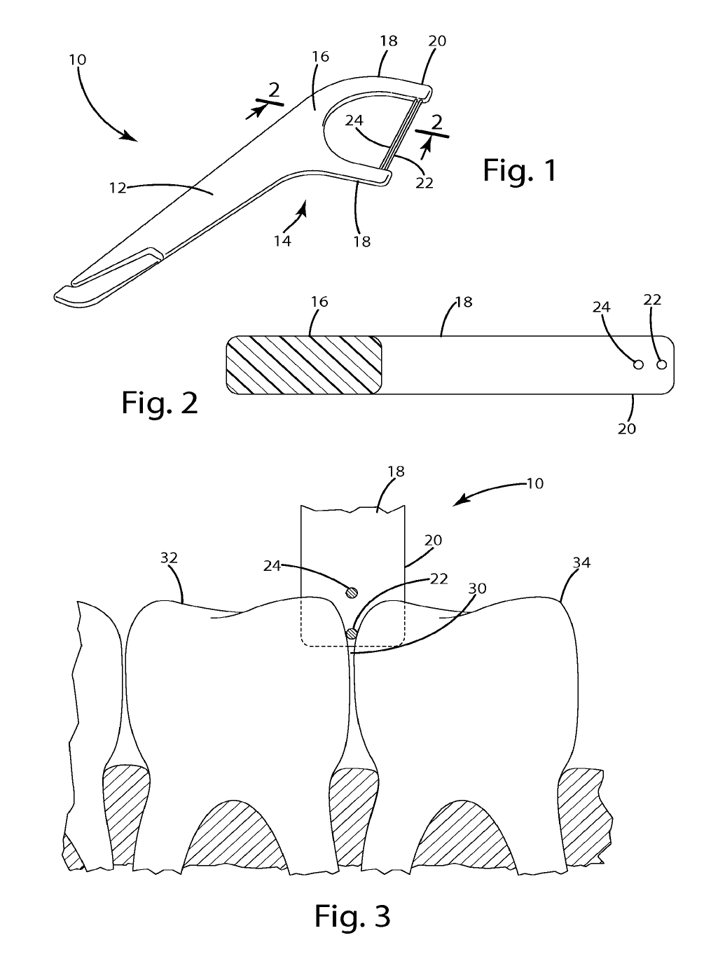

A multiple strand dental flosser according to one embodiment of the present invention is shown in FIGS. 1-3 and generally designated 10. In one embodiment, the flosser 10 is formed of an injection-molded plastic handle part 12 and flosser head 14, the latter having a generally U-shape or V-shape comprising a base part 16 and extending from the base part a pair of spaced apart arms 18 which are generally parallel to each other, each ending a remote terminal end part 20.

Extending transversely between and fixed to the terminal end parts 20 of each flosser is a set of two adjacent generally parallel strands of dental floss, including lead strand 22 and follower strand 24. In one embodiment, the lead strand 22 is made of PTFE for its extremely slippery (low coefficient of friction) characteristic, and the follower strand 24 is made of UHMWPE for its greater strength and resistance to stretching or shredding. The UHMWPE strands may be 400 denier UHMWPE strands that include 120 microfilaments configured with a Z twist, as are available from Honeywell International Inc. or other commercial suppliers. The PTFE or Teflon® floss is also readily available from many commercial sources, and in one embodiment, the PTFE floss is 200 denier PTFE floss.

Manufacture of the flosser 10 may be conducted in a conventional manner, for instance, by injection molding the flosser 10 in a mold, with the strands of floss placed in the mold prior to molding, such that the arms 18 of the flosser 10 are molded about the strands of dental floss. In one embodiment, multiple flossers 10 may be formed simultaneously in a multi-cavity mold where the plurality of cavities are aligned so that each of the dual strands can be extended in a straight line transversely across all the arms of the aligned flosser cavities. Strands of floss are positioned in grooves in a mold surface between the cavities, so that on closing the mold parts the strands are not crushed. The strands are placed in tension, (a) to make sure they remain straight while traversing the arms of the flosser cavities and remain in the grooves between the cavities, and (b) to incorporate a pre-stretch in each strand to reduce the stretching that might occur in use. In this pre-injection stage the PTFE strand may be stretched about 15% and the UHMWPE strand may be stretched about 3½%. In one method of manufacture, the UHMWPE strands are given about four twists per inch by known twisting techniques to enhance the strength and resistance to stretching of the UHMWPE floss strand to about 3% as compared to a stretch of about 3½% without the further twists. In one embodiment, the flosser may also be manufactured such that the floss strands have differing amounts of tension. For example, the one of the floss strands (whether the strands are formed from the same or different materials) may be provided with a greater amount of pre-stretch than the other strand, or one of the floss strands may be placed in the mold cavity with a predetermined amount of slack.

A variety of different injection molded plastics may be used for form the handle part 12 and the head part 14. Current examples include polystyrene, polyethylene or polypropylene. Both of these plastics have melting temperatures below that of PTFE and/or UHMWPE, so that the dental floss will not be melted or otherwise damaged when the molten plastic for the arms of the floss head is injected around and about the outer surfaces of the portions of the floss extending across the arm portions of the flosser in the mold cavity.

Conventional multi-cavity injection mold and manufacturing techniques produce skeleton-connected aligned molded flossers, with a set of continuous dual strands of floss extending transversely through the end portion of the arms of the aligned flossers. These flossers may subsequently be separated by severing the segments of floss extending between the arms of adjacent flossers where the severing may be made by a hot knife, laser or flame. By this technique the exposed ends of the strands are melted and formed into beads having greater diameter or greater cross-sectional area than that of the original strands, thus restricting the portion of each strand embedded in the arm from pulling through during use of the flosser. The bead may be a single mass of the melted fibers of the strands or multiple tiny beads of the coalesced ends of the fibers and appearing somewhat like a cauliflower. In another embodiment, the adjacent flossers 10 may be separated by cutting the floss strands with a different cutting device that does not melt the strands. If necessary, the strands may be retained in the floss arms by knotting the ends of the strands, or by chemically bonding the floss material to the material used to form the flosser arms 18.

Use of the new dual strand flosser 10 is shown schematically in FIG. 3, which illustrates the remote ends 20 of arms 18 with lead strand 22 beginning to enter the interstice 30 between two adjacent teeth 32 and 34, and immediately adjacent follower strand 24 of UHMWPE positioned to enter the interstice 30 as the flosser 10 is moved downward in the direction of arrow 36. In such a tight interstice it will be easier to negotiate the more slippery lead strand 22 first, which will begin the process of scrubbing the adjacent tooth surfaces; the follower strand 24 which is stronger and less slippery will continue the scrubbing process.

In keeping with the general concept of employing two flosses having different material characteristics in the same flosser, it is also possible for a flosser to have the lead strand be of a stronger material, as UHMWPE and the follower strand to be of a more slippery material, as PTFE. This combination might be preferred for extremely tight interstices which may cause a lead strand of PTFE to stretch while a lead strand of stronger UHMWPE would not. In another embodiment, the floss strands may have other characteristics that are varied. For instance, one of the strands may be provided with a coating, such as a wax coating or another coating that changes the coefficient of friction of that particular strand, whereas the other strand may be uncoated. Other types of coatings may be provided to one of the floss strands, including, but not limited to, flavor agents, oral care agents and abrasives, and each floss strand may be coated with a different coating that cooperates with the coating of the other strand to provide enhanced cleaning effects.

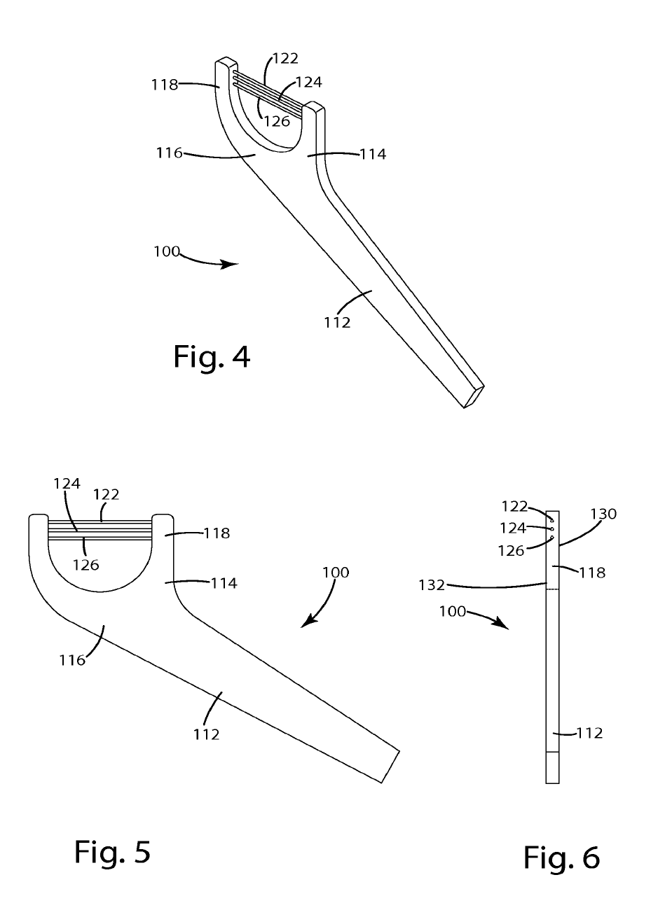

A second embodiment of the dental flosser is shown in FIGS. 4-6. In this embodiment, the dental flosser 100 includes a handle part 112 and a head part 114 that are substantially similar to the dental flosser 10 described above. The head part 114 includes a base 116 and a pair of arms 118 extending from the base 116. Three strands of floss 122, 124, 126 extend between the arms 118. In the illustrated embodiment, the three strands 122, 124 and 126 are generally parallel to each other, and are spaced about five millimeters from each other, although the spacing may be varied. FIG. 6 (a side view of the flosser 100) shows the ends of the floss strands 122, 124, 126, in an embodiment wherein in the floss strands extend through the arms 118. As shown, the floss strands 122, 124, 126 are aligned when viewed down the length of the arms 118, and are positioned generally along the midline of the width of the flosser arms 118 between a front surface 130 and a rear surface 132 of the flosser arms 118. At least one of the strands 122, 124 and 136 may have different material characteristics than at least one other strand. For instance, the lead strand 122, or the first two strands 122, 124, may be formed from PTFE, to enable smooth insertion into the interstices between the user's teeth, and the two follower strands 124, 126 (or only the third strand 126) may be formed from the stronger UHMWPE material. Alternate arrangements of UHMWPE and PTFE may also be used, in addition to one or more of the strands being provided with other material characteristics, such as coatings or additives. The addition of third strand of floss (and perhaps additional strands of floss) enables more combinations of dental floss strands with differing material characteristics to provide each flosser 100 with a desired set of floss properties. The additional strand of floss also provides even greater contact surface between the floss and the user's teeth, to enhance the cleaning effects of the flosser 100.

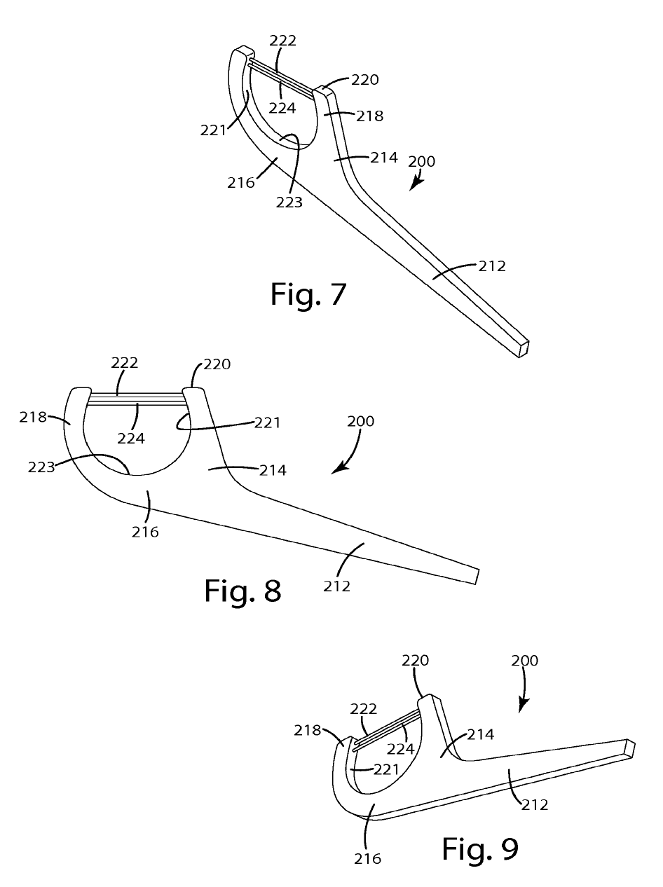

A third embodiment of the dental flosser 200 is shown in FIGS. 7-9. In this embodiment, the dental flosser 200 includes a handle 212 and a head part 214. The head part 214 includes a base 216, and a pair of arms 218 that extend from the base 216. As shown, the arms generally converge toward each other, such that the distal ends 220 of the arms 218 are closer together than the distance between the arms 218 at the base 216. In the illustrated embodiment, the arms 218 curve inwardly and the inner surface 221 of the arms, along with the upper surface 223 of the base 216 form a continuously curved surface. A pair of dental floss strands 222, 224 extend between the arms 218 in a manner similar to the first embodiment. The convergence of the arms 218 causes a difference in the relative lengths of the two floss strands 222, 224. More particularly, the exposed length of the lead strand 222 between the arms 218 is shorter than the exposed length of the follower strand 224. As a result of the difference in lengths between the floss strands 222, 224, the longer follower strand 224 may be deflect a greater distance than the lead strand 22 when the two strands are inserted between a user's teeth. The lead strand 222 thus remains taught for easy insertion between the teeth, while the increased deflection of the follower strands enables a larger surface area of the strand 224 to contact the user's teeth. The floss strands 222, 224 may be made from the same materials, and may have the same material characteristics or, as described above, they may be formed from different materials or be provided with differing material characteristics. In one embodiment, the lead strand 222 is formed from PTFE and the follower strand 224 is formed from UHMWPE, although other arrangements maybe used.

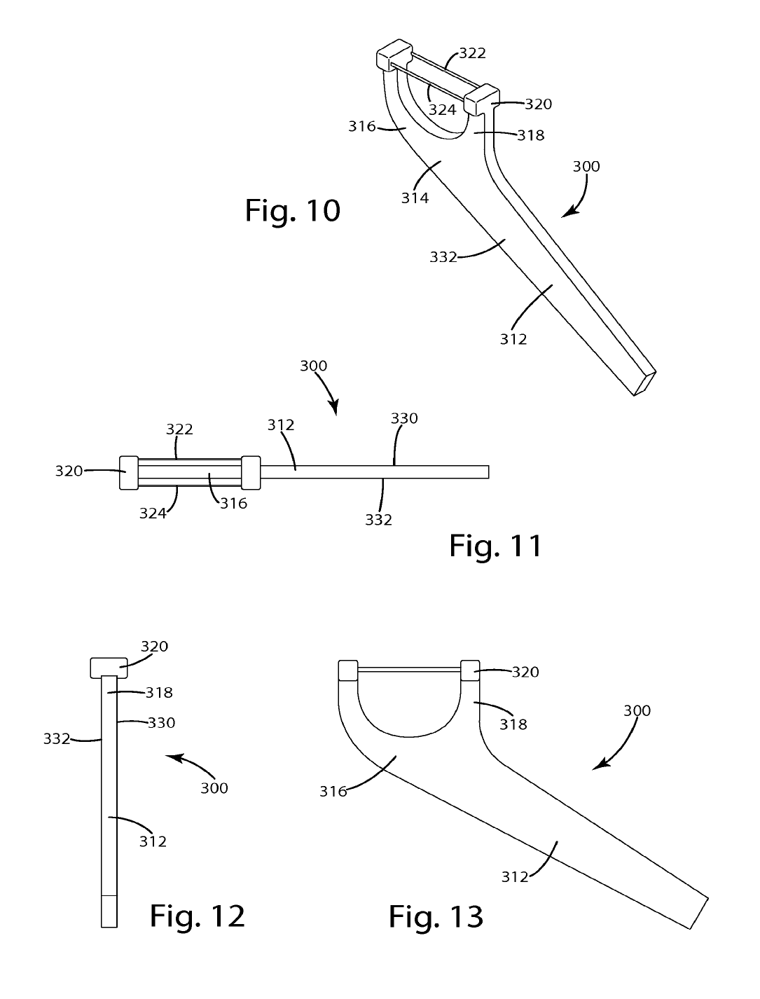

A fourth embodiment of the dental flosser is shown in FIGS. 10-13. In this embodiment, the flosser 300 includes a handle part 312 and a head 314 having a base 316 and a pair of arms 318 extending from the base 316. The flosser 300 and flosser arms 318 generally include a front surface 330, a rear surface 332, and a width defined between the front and rear surfaces 330, 332. As shown, each arm includes a distal end portion 320 that projects outwardly from the front 330 and rear 332 surfaces of the arm 318, such that the distal end portion has a width that is greater than the width of the arms 318. A pair of dental floss strands 322, 324 extend between the arms 318 at the distal end portion 320 of the arms 318. In contrast to the previously described embodiments, the strands 322, 324 of this embodiment are aligned in a plane that extends generally perpendicular to the planes defined by the front 330 and rear 332 surfaces of the flosser 300, and perpendicular to the longitudinal extent of the arms 318. The width of the distal end portions 320 enable the floss strands 322, 324 to be spaced apart from each other at a distance that is greater than the width of the remainder of the arms 318 and the flosser 300. In one embodiment, the strands of floss 322, 324 are spaced apart at approximately the average width of a tooth, such that the flosser 300 can be used to extend the strand of floss 322, 324 into different interstices at the same time. Put another way, this arrangement allows a user to floss both sides of a tooth at the same time.

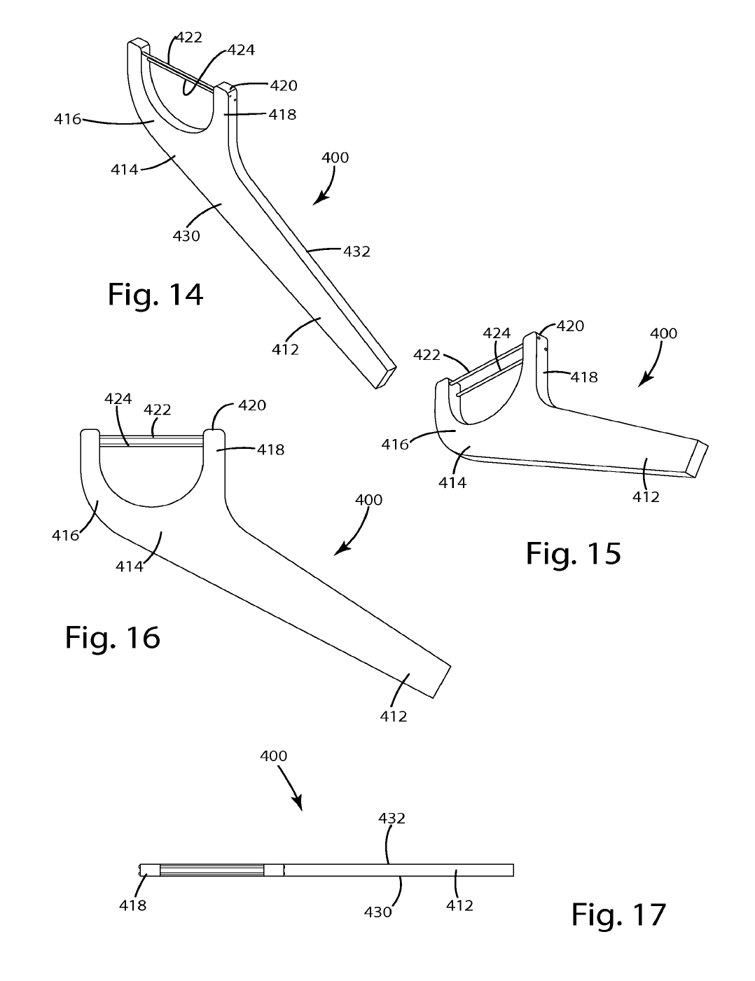

A fifth embodiment of the flosser is shown in FIGS. 14-17. In this embodiment, the flosser 400 includes a handle 412, head 414, base 416 and arms 418 that are substantially the same as the first described embodiment. The arms 418 each include a longitudinal length extending between the distal end 420 of the arm 418 and the base 416, and a width extending between the front surface 430 of the arm 418 and the rear surface 432 of the flosser arm 418. A pair of dental floss strands 422, 424 extend between the arms 418. The strands 422, 424 extend generally parallel to each other, and are spaced apart along both the longitudinal length of the arms and the width of the arms, such that the strands 422, 424 are staggered along the length of the arms 418. As shown in FIGS. 14-17 (which illustrate how the floss strands 422, 424 may extend completely through the arms 418), the floss strands 422, 424 are positioned such that the lead strand 422 is nearer to the front surface 430 and the follower strand 424 is nearer to the rear surface 432. This arrangement of staggered, parallel floss strands may enable the strands to have increased engagement with the surfaces of the teeth as the strands are inserted between one of the interstices between adjacent teeth to provide an enhanced cleaning effect. As with the previous embodiments, the strands 422, 424 may be made from the same materials with the same material characteristics, or one of the strands may have a material characteristic that is different from the other strand. Additional strands of floss may also be added to the flosser 400, for instance, by staggering the strands in an alternating pattern along the length of the flosser arms 418.

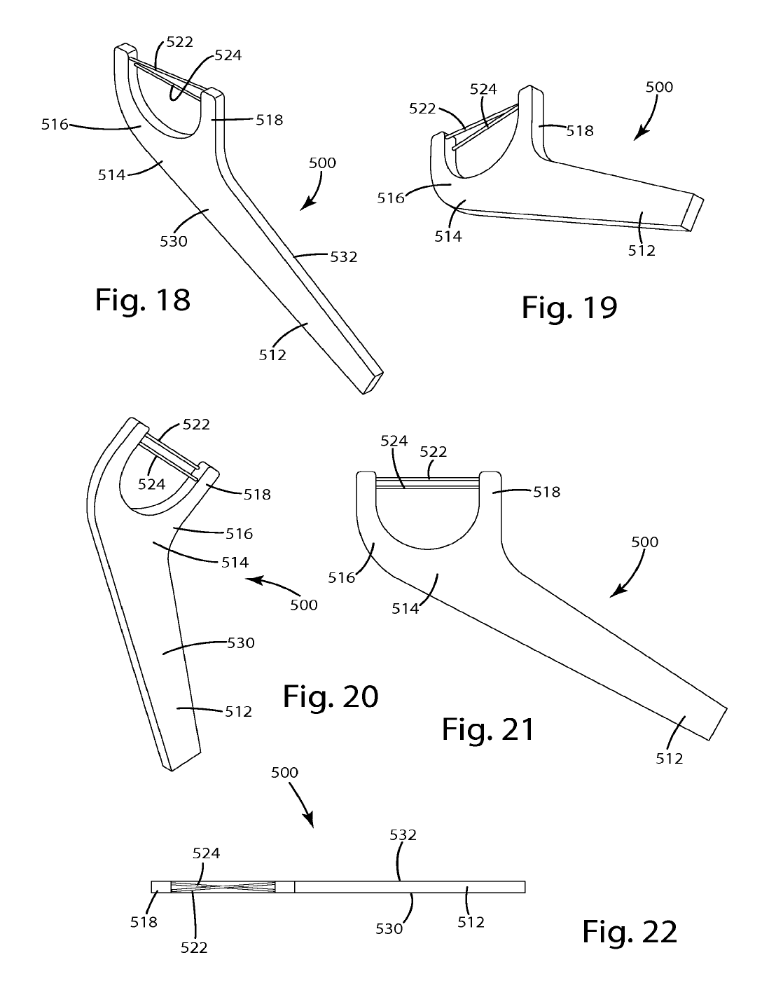

A sixth embodiment of the flosser is shown in FIGS. 18-22. In this embodiment, the flosser 500 includes a handle part 512 and a head 514 including a base 516 and a pair of arms 518 extending from the base 516. The handle 512, head 514, base 516 and arms 518 of this embodiment are substantially similar to those of the first described embodiment. As illustrated, in this embodiment, the flosser 500 includes a pair of floss strands 522, 524 that are spaced apart and generally parallel in a first direction, but are angled with respect to one another in a second direction. More particularly, as shown in FIG. 21, the strands 522 and 524 are spaced apart along the longitudinal length of the arms 518, and are parallel to each other in a direction generally perpendicular to the longitudinal length of the arms. The floss strands 522, 524 extend at an angle with respect to a plane defined by the front 530 and rear 532 surfaces of the arms 518. As shown, the lead strand 522 extends from a position adjacent the front surface 530 of a first one of the arms to a position adjacent the rear surface 532 of the other arm 518. The follower strand extends from a position adjacent the rear surface 532 of the first one of the arms 518 to a position adjacent the front surface 530 of the other one of the arms 518. As a result, (shown in FIG. 22) the strands 522, 524 cross each other at approximately the midpoint between the two arms 518. The crossing of the strands in one direction may provide advantages in flossing. For example, a user can insert the midpoint of the floss strands between the user's teeth for relatively easy insertion, and then slide the flosser back and forth to cause the portions of the floss strands 522, 524 near the arms 518 to engage the teeth. The spacing between the floss strands 522, 524 near the arms 518 may increase the engagement with the teeth and provide an enhanced cleaning effect. As in the previous embodiments, one of the floss strands may have different material characteristics than the other floss strand, for instance, one of the floss strands may be formed from PTFE and the other from UHMWPE.

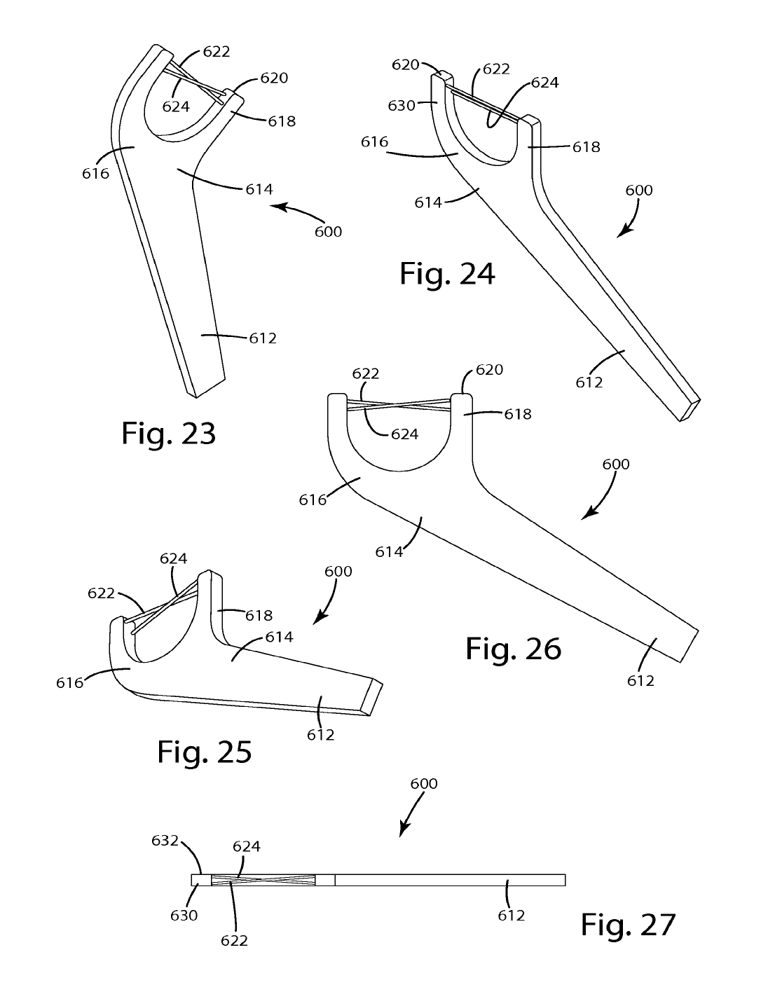

A seventh embodiment of the flosser 600 is shown in FIGS. 23-27. In this embodiment, the flosser 600 includes a handle part 612 and a head 614 including a base 616 and a pair of arms 618 extending from the base 616. The handle 612, head 614, base 616 and arms 618 of this embodiment are substantially similar to those of the first described embodiment. As illustrated, in this embodiment, the flosser 600 includes a pair of floss strands 622, 624 that are each angled in two directions. As shown in FIGS. 23-26, the strands are angled with respect to the longitudinal axis of the arms 618, such that a first one of the strands 622 is closer than the other strands 624 to the distal end 620 of one of the arms 618, and the first one of the strands 622 is farther from the distal end 620 of the other arm 618 than the strand 624. In addition, the strands are angled in the same manner as the flosser 500, wherein the first strand 622 extends from a position adjacent the front surface 630 of a first one of the arms to a position adjacent the rear surface 632 of the other arm 618. The other strand 624 extends from a position adjacent the rear surface 632 of the first one of the arms 618 to a position adjacent the front surface 630 of the other one of the arms 618. As in the flosser 500, the ends of the strands 622, 624 are spaced apart evenly along the longitudinal length and along the width of both arms, such that the two strands cross each other at approximately the midpoint between the two arms 618 when viewed from the side (FIG. 26) and from the top (FIG. 27). In one embodiment, the strands 622, 624 may contact each other at approximately the midpoint between the two arms 618. The material characteristics of the strands 622, 624 may be varied in the same manner as described above in connection the previous embodiments.

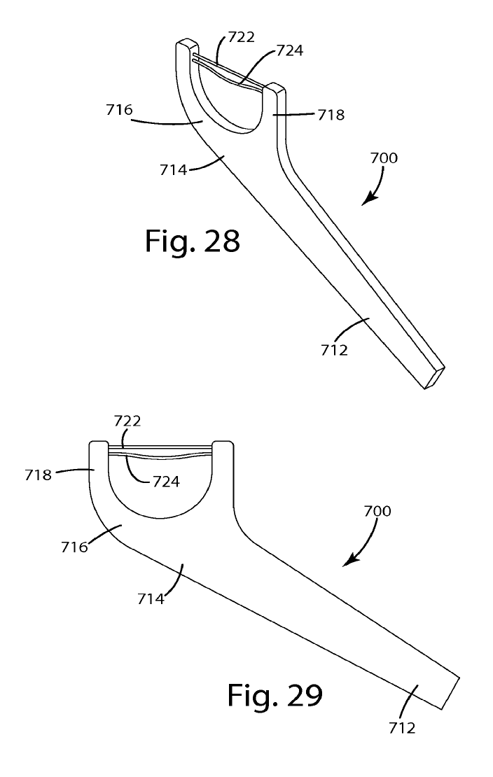

An eighth embodiment of the present invention is shown in FIGS. 28-29. As noted above, in one embodiment, the floss strands may also be manufactured to have a predetermined amount of tension. For instance, one strand may be inserted into the mold cavity with a greater amount of pre-stretch than the other strand, or with a predetermined amount of slack. FIGS. 28-29 show an embodiment of the flosser 700 that includes a handle 712, head 714, base 716 and arms 718 extending from the base that are substantially similar to the first described embodiment. The flosser 700 includes a lead dental floss strand 722 and a follower dental floss strand 724. As shown, the lead strand 722 has a greater degree of tension than the follower strand 724. The follower strand 724 is provided with a degree of slack, such that the strand 724 is non-linear as it extends between the flosser arms 718. In an alternative embodiment, the strands may vary in tension simply by providing each strand with a different amount of pre-stretch. The differences in tension may vary the amount of surface area on each strand that contacts a user's teeth during use. Other methods for changing the tension in one or more of the floss strands may also be used. For example, one of the floss strands may be cut to a longer length than the other strand, and heated for form knots in the ends of the floss strands similar to that described above. In this embodiment, the longer floss strand will have less tension than the shorter strand as the floss strands slide within the flosser arms and are retained by the knots.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A dental flosser comprising:
a. a plastic handle having proximal and distal ends,
b. a flosser head at said distal end of said handle,
c. said flosser head including a base part and two spaced apart arms extending from said base part, said spaced apart arms each having a distal end portion,
d. first and second strands of dental floss extending transversely between said distal end portions of said spaced apart arms,
e. said first strand being more remote from said base part than said second strand, and
f. said first and second strands having different material characteristics from each other.

2. A dental flosser according to claim 1 wherein said first strand has the lower coefficient of friction of said first and second strands.

3. A dental flosser according to claim 1 wherein said first strand is formed from a different material than said second strand.

4. A dental flosser according to claim 1 wherein said first strand is formed of PTFE microfibers.

5. A dental flosser according to claim 4 wherein said second strand is formed of UHMWPE microfibers.

6. A dental flosser according to claim 1 wherein said second strand is a 400 denier floss having about 120 microfilaments.

7. A dental flosser according to claim 1 wherein said second strand comprises UHMWPE with a Z twist configuration.

8. A dental flosser according to claim 1 wherein said spaced apart arms each include a longitudinal length and a width, said first strand being offset from said second strand along said width.

9. A dental flosser according to claim 8 wherein said first strand and said second strand extend parallel to each other, said first strand and said second strand lying in a plane that is angled with respect to said longitudinal length of said arms.

10. A dental flosser according to claim 1 including a third strand of dental floss, said third strand being closer to said base than said second strand.

11. A dental flosser according to claim 1 wherein said first floss strand has a different amount of tension than said second floss strand.

12. A dental flosser according to claim 1 wherein said spaced apart arms converge toward each other as said arms extend away from said base, such that the length of said first strand between said arms is less than the length of said second strands between said arms.

13. A dental flosser comprising:
a plastic handle having proximal and distal ends,
a flosser head at said distal end of said handle,
said flosser head having a base part and two spaced apart arms extending from said based part, said spaced apart arms each having a longitudinal length, a width and a thickness, and
first and second strands of dental floss extending transversely between said spaced apart arms and through at least a portion of said thickness of said arms, wherein said first strand and said second strand extend from one of said arms at different positions along said width.

14. The dental flosser of claim 13 wherein said first and second strands extend parallel to each other.

15. The dental flosser of claim 13 wherein said first and second strands do not extend parallel to each other.

16. The dental flosser of claim 15 wherein said first and second strands cross each other.

17. The dental flosser of claim 16 wherein said first strand has a first end and a second end, and wherein said second strand has a first end and a second end, said first ends of said strands extending from one of said arms, said second ends of said strands extending from the other one of said arms, wherein said arms include a front surface and a rear surface opposite said front surface, and wherein said first end of said first strand is closer to said front surface than said first end of said second strand, and said second end of said first strand is closer to said rear surface than said second end of said second strand.

18. The dental flosser of claim 17 wherein said arms each include a distal end, and wherein said first end of said first strand is closer to said distal end than said first end of said second strand, and said second end of said second strand is closer to said distal end than said second end of said first strand.

19. The dental flosser of claim 18 wherein said first strand and said second strand cross each other at approximately the midpoint between said arms.

20. A dental flosser comprising:
a plastic handle having proximal and distal ends,
a flosser head at said distal end of said handle,
said flosser head having a base part and two spaced apart arms extending from said based part, said spaced apart arms each having a front surface and a rear surface, and
first and second strands of dental floss extending transversely between said spaced apart arms, wherein a portion of said first strand is positioned closer to said front surface than a portion of said second strand, and wherein one of said first and second floss strands has different material characteristics than the other of said first and second floss strands.
